(19) United States
(12) Patent Application Publication
(10) Pub. No.: US 2005/0192925 A1
(43) Pub. Date: Sep. 1, 2005

(54) Enterprise information system architecture (EISA)

(76) Inventor: Terry Lee Nichols, Palm Coast, FL (US)

Correspondence Address: Terry Lee Nichols, 38 Seascape Drive, Palm Coast, FL, 32137, US

(21) Appl. No.: 11/037,854

(22) Filed: Jan. 18, 2005

Related U.S. Application Data
(60) Provisional application No. 60/537,366, filed on Jan. 16, 2004.

(51) Int. Cl. G06F 7/00

(52) U.S. Cl. 707/1

(57) ABSTRACT

A method and system for Enterprise Information System Architecture provides a standardized enterprise information architecture with the ability to share data, provide a consistent user access method, connect application logic to data, provide a uniform method to connect interfaces with applications, interact with workflow, interact with external systems, provide a unified navigation architecture schema, provide a standard security schema, provide an integrated documentation methodology, and provide pathways for time-based processes for data, programs, workflow and documentation. This architecture provides a single overarching system with system development and diverse enterprise information system integration capabilities.

### CROSS REFERENCE TO RELATED APPLICATION

This application claims priority of Nichols's U.S. Provisional 168765 Application Ser. No. 60/537,366 filed on Jan. 16, 2004, entitled “_Enterprise Information System Architecture (EISA)_,” the contents of which are incorporated herein by reference in their entirety including the contents and teachings of any references contained therein.

### TECHNICAL FIELD

The invention relates generally to “Enterprise Software Systems” and, more particularly, to “Infinitely Configurable Enterprise Information Architecture”, “Enterprise Operating System”, “Security”, “Data Integration”.

### BACKGROUND OF THE INVENTION

Today's enterprise software world does not have an architecture that governs the manner in which enterprise software systems are created. This lack of standards creates an environment full of applications that cannot share data, cannot provide a consistent user access method, cannot uniformly connect application logic to data, cannot provide a uniform method to connect interfaces with applications, cannot interact with workflow, cannot interact with external systems, cannot provide a unified navigation architecture schema, does not provide a standard security schema, cannot provide an integrated documentation methodology, and cannot provide pathways for time-based processes for data, programs, workflow and documentation. The resulting islands of functionality, yields a patchwork enterprise information technology landscape where all system components from one system can not be reached or synchronized with components from another, including legacy systems and backend systems of record. In short, today's enterprise is burdened with a jumble of standards, platforms, systems and applications that have no way in which to provide unified information access and control. Our invention, Enterprise Information System Architecture, as this patent application shows, solves uniquely this problem.

### SUMMARY OF THE INVENTION

In accordance with the foregoing architecture for developing enterprise systems, the invention provides a standardized enterprise information architecture with the ability to share data, provide a consistent user access method, connect application logic to data, provide a uniform method to connect interfaces with applications, interact with workflow, interact with external systems, provide a unified navigation architecture schema, provide a standard security schema, provide an integrated documentation methodology, and provide pathways for time-based processes for data, programs, workflow and documentation. This architecture provides a single overarching system with system development and diverse enterprise information system integration capabilities.

In particular, our invention, Enterprise Information System Architecture, as this patent application shows, uniquely solves the problems summarized in the above section entitled BACKGROUND of the INVENTION. Our invention uniquely brings order to the situation described above via its overarching Enterprise Information System Architecture, wherein each of the underlying systems summarized above becomes a fully integrated contributing and controllable entity presented to the Enterprise via our overall Enterprise front end.

Additional features and advantages of the invention will be made apparent from the following detailed description of illustrative embodiments that proceeds with reference to the accompanying figures.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is System Addressability . . .

FIG. 2 is External Integration Architecture

FIG. 3 is Enterprise Information External architecture

FIG. 4 is Menu Nodes

FIG. 5 is Work Flow Folder Examples

FIG. 6 is Work Flow Structure Flexibility

FIG. 7 is Process Invocation

FIG. 8 is Task Builder Screen Shot Examples

FIG. 9 is Workflow Model

FIG. 10 is Web Services Architecture

FIG. 11 is Data Communication Menu

FIG. 12 is Time Based Task Processing

FIG. 13 is Position Basic Data Menu

FIG. 14 is Security Schema

FIG. 15 is Date-Layer Screen

FIG. 16 is Security Login Screen

### DETAILED DESCRIPTION OF THE DRAWINGS

Overview

Our overarching Enterprise Information Systems Architecture (EISA) connects all of an enterprise's various systems into a cohesive whole within a single enterprise architecture. The architecture provides important capabilities including an n*n*n component-based architecture, an open enterprise integration infrastructure which includes open collaboration with all external system components, process integration with comprehensive exchange infrastructure, infrastructure management, compliance with open internet and industry standards, time-based task processing and model-based cascading security.

Design Philosophy

Throughout EISA, a unique design philosophy permeates all aspects of the system. This philosophy is based on nodes that represent the logical unit of work and its place in the overall enterprise structure.

True to its modular design, the architecture makes it possible to reflect complex processes which connect to workflow based one table/one task methodology. This design provides a place for everything related to enterprise software. The architecture uses a hierarchy of small reusable modules that are grouped to represent system entities.

EISA enables all data stores and the procedures that affect them to be put together in a one-to-one fashion. One table and one procedure becomes the norm. EISA moves complex relationships among related tables and procedures out from the tables and procedures themselves and into EISA's Advanced Connector Logic technology space, leaving the code directly related to the maintenance of individual tables unadulterated by foreign and dependency-creating relationship & workflow code. By factoring work flow & relationship code out away from the tables and the procedures that maintain them, one change to a complex relationship does not break all participants in that relationship.

System Design Overview

is a standards-based approach to solving complex system design and application integration challenges. The architecture is based on a hierarchical node-based model which provides the system designer with the framework and instruments to produce and host systems, applications, menus and individual end user work areas where select work tasks are determined, and subsequently performed.

Architecture Addressability

The architecture utilizes a hierarchical numbering schema to identify each system component. For example, the address for the first node is 1.0. The third child of the first node will have an address of 1.3. The 5^{th} child of the third node will have an address of 1.3.5, and so on. There are an infinite number of nodes at any level.

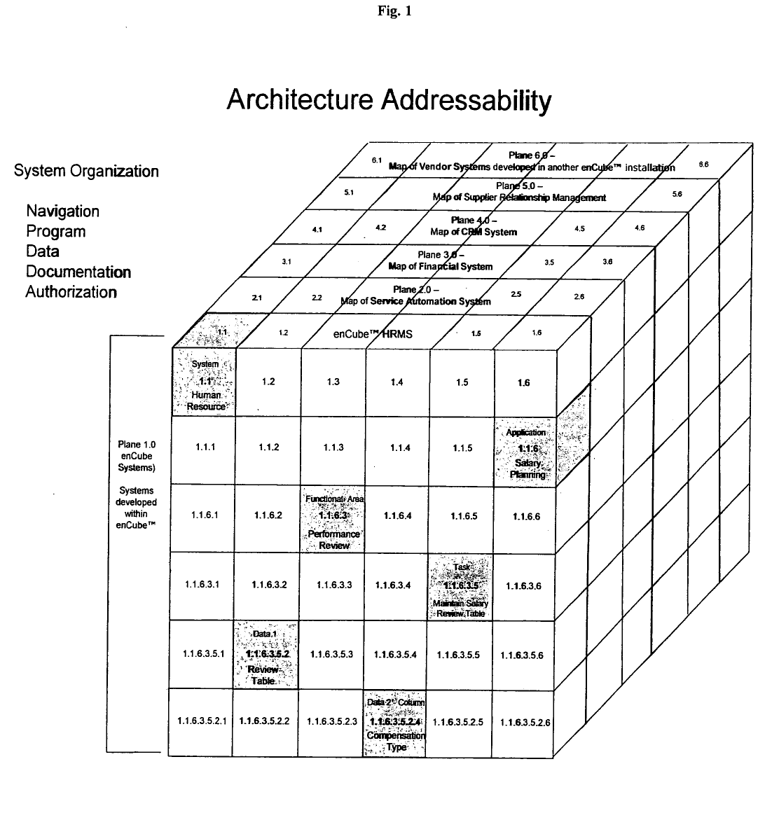

The n*n*n architecture is a hierarchical structure comprised of system nodes may represent navigation, functional work areas, tasks, sub tasks and workflow. The purpose of the structure is to ensure a logical series of related steps and processes that produce the desired results. As navigations, work areas, and tasks are created, the objects that result from the design are defined to the architecture and a road map of the creation process established. This is accomplished using an allocation table that contains a blueprint of the creation process from the parent node, through the lowest child node which comprises actual data elements defined to a particular task. See FIG. 1.

External System Architecture Addressability

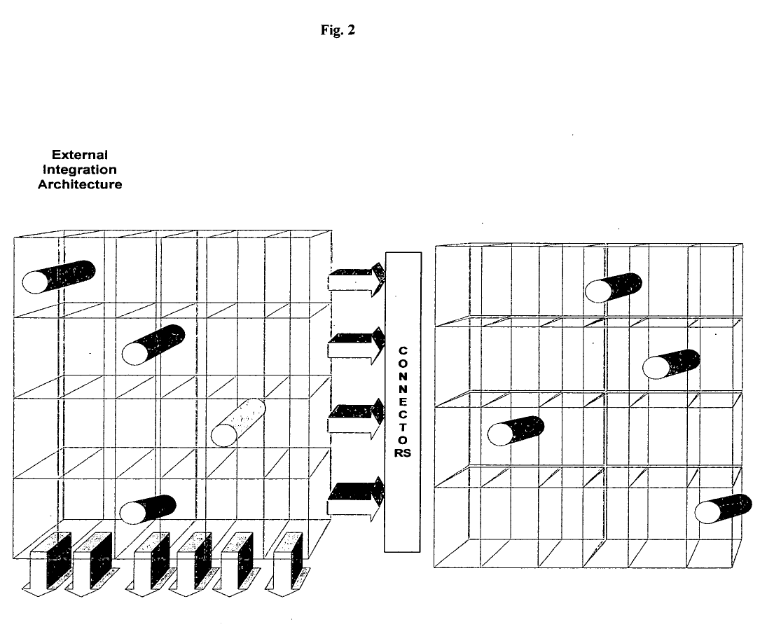

The architecture also utilizes a hierarchical numbering schema to identify each external system component. External system addressability uses the same numbering schema found in the core architecture numbering schema
1. Connectors are used to integrate any external system component—menus, functional areas, tasks, sub-tasks and workflow—with the core architecture. The logical construct provides an extended architectural layer designed for interaction, integration, and evolution of components. See FIG. 2.
   External System Integration

EISA's infinitely configurable node architecture is designed to facilitate integration, interfacing or evolving any functional component from any external application. For example, an external application may have several menu items that it would be nice to be able to activate from within EISA's menu structure directly. Instead of having to open SAP and select these menu items, it makes more sense to group them with other EISA work-area tasks to achieve better integration and functional grouping.

To bring this integration with EISA even further along, EISA can trigger background tasks to follow the execution of one of these third Party application tasks that has been initiated from an EISA Work Area. An example of a background task following a 3rd Party application's task might be to synchronize data altered by the third Party task with data in an EISA table for instance.

Each background task can be built with EISA's Background Builder and assigned to follow a particular third Party EISA activated Task via assignment in DNA Builder. This assignment maps to potentially every third Party task, an EISA Background task, which in turn can be the start point for an EISA Workflow or Communicator Process or any combination thereof. The power and flexibility is simply limitless, while always operating under the protection of the EISA Security and Enterprise Application Infrastructure Control.

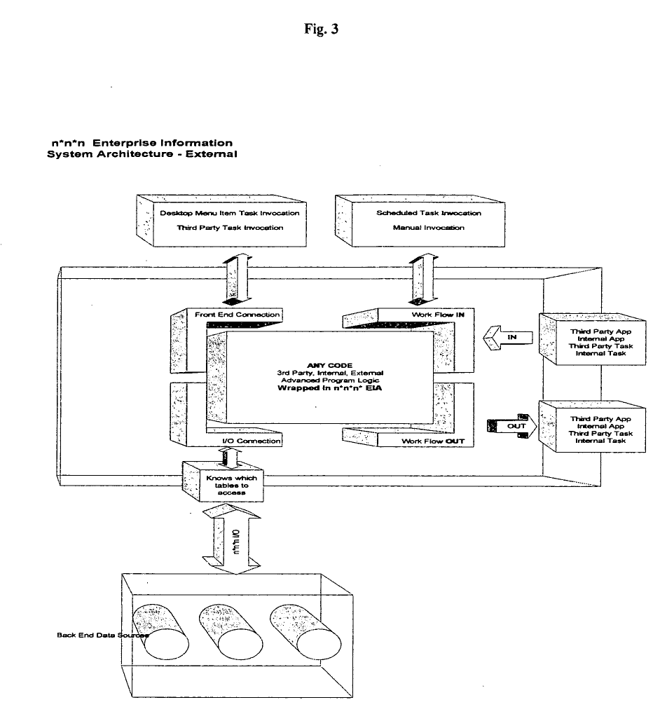

See FIG. 3.

Menu Nodes

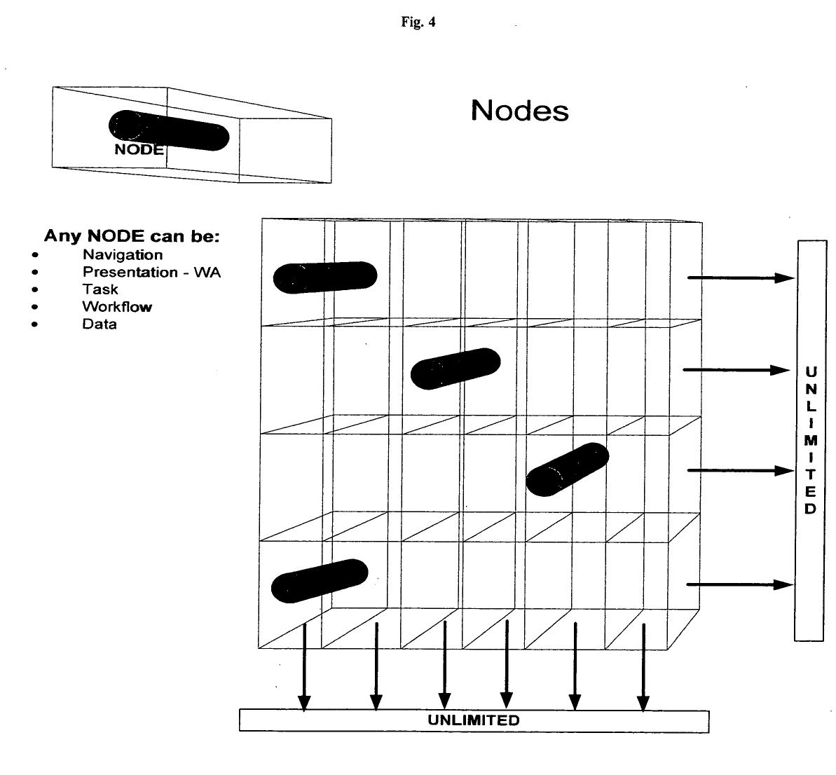

Menus, when placed at any node preceding a task, are designed to provide systematic pathways to work areas. See FIG. 4.

Work Area Nodes

Work area nodes may employ a variety of structure types including:
DNA
Tree Structure
Linear Folders
Hierarchical Folders
Graphical Desktops
Image Map

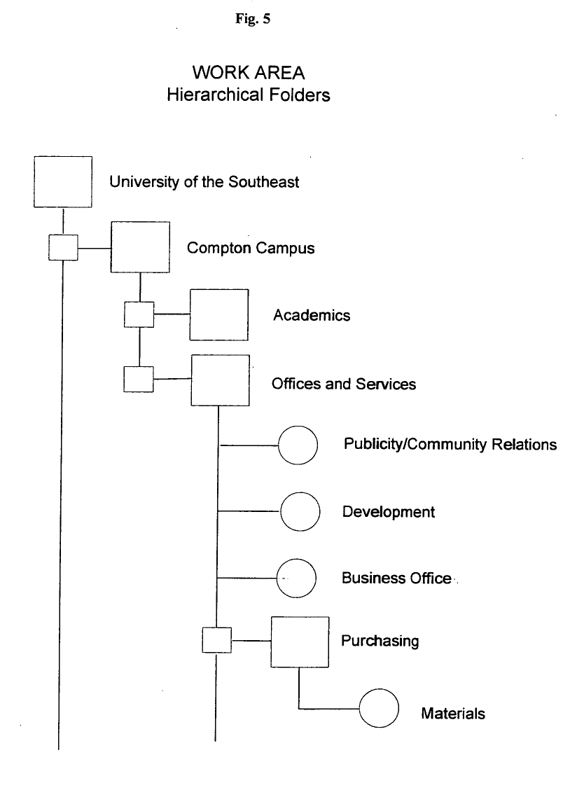

The purpose of a work area for launching tasks, sub-tasks and workflows. Examples are seen in FIG. 5.

Work Area Organizational Structure Flexibility

The architecture provides the ability to design organizational structures on demand.

The following attached image is and discussion addresses the native ability to perform Enterprise Design Organizational Structure manipulations.

The discussion specifically concerns the swapping of levels in an enterprise design diagram. Further, the impact of such a swap and what exactly a swap means from a tables and records perspective within the architecture is discussed.

Notice in the image that we have three levels and their respective ordering before we swap:
1. Client and its Client table
2. Country and its Country table
3. State/Region and its Region table

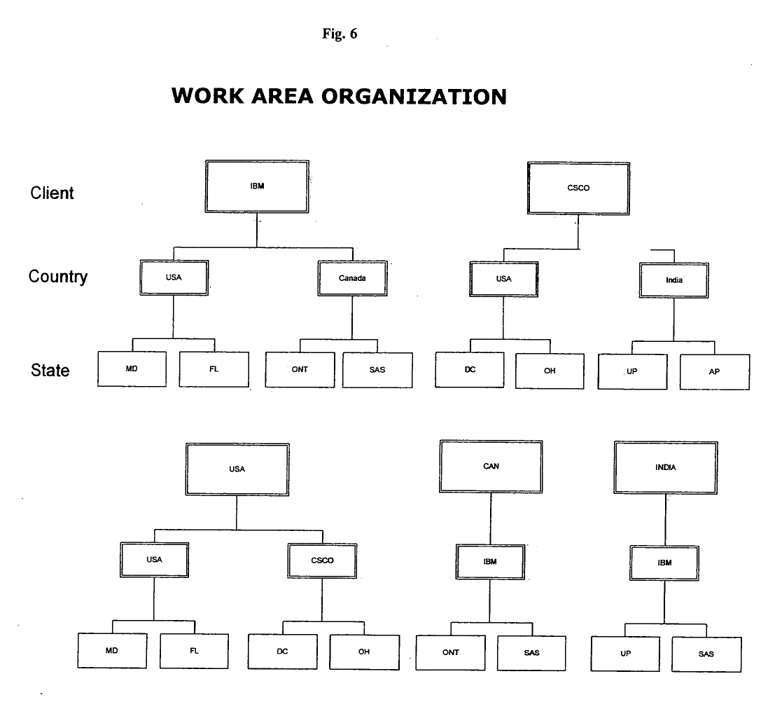

See FIG. 6.

In FIG. 6 we desire to swap levels 1 and 2 and examine the impact, show how the trees would have to look, and what would happen to each of the tables and their records.

After swapping levels one and two, we have:
1. Country and its Country table
2. Client and its Client table
3. State/Region and its Region table

Let us look at the situation before we swap levels:

The Client table has 2 records in it, one for IBM and one for CSCO

The Country table has four records in it, USA twice and Canada and India once each and this is so because USA occurs under both clients IBM and CSCO whereas Canada occurs under only IBM and India occurs only under CSCO.

The State/Region table has eight records in it, for each region, i.e. MD, FL, under the USA; ONT, SAS, under Canada, and UP and AP under India.

Now let us look at the situation AFTER levels one and two, i.e. Client and Country, are swapped to be Country and Client.

After the level swap, this is what we have:

The Country table goes from having four records in it, to only three countries in it, i.e. 1 record for USA, 1 record for Canada, and one record for India.

The Client table goes from having only 2 records in it, to having 4 records in it, with IBM occurring twice, once under USA and once under Canada, whereas before the swap, IBM only occurred once in the Company table.

Finally, the State/Region table does not change in terms of number of records.

Of course, the table, which records the parent child relationships, will also have to change whenever level changes occur as well.

The architecture supports level changes without manual intervention.

Task Nodes

This is the final menu level node created within the architecture, and like the other levels, the parent-child relationships are established at superior nodes. At this level, the end user or process scheduler will select the actual tasks that are available to support the logical unit of work.

A System is composed of one or more related Applications, which in turn is composed of one or more related Work Areas, which in turn is composed of one or more related Tasks and their tables.

All menus leading up to the tasks themselves are purely navigational. Until a task is invoked, processing consists of rendering the next level of menus based on the previous level and the sub menu chosen, the identity and security profile of the user and the deployment descriptors for that node.

Once a Task within a particular Work Area has been selected, a logical unit of work is performed on a table which can in turn trigger an interactive event, or a scheduled event. In either case, the details of execution take place within a background process/daemon technology to marshal all work flows from a scheduling and fault tolerance perspective.

Tasks are comprised of the following components: Internal Application Source Invocation (Menu, Scheduled, or workflow invoked), External Application Source Invocation (Menu, Scheduled, or workflow driven), and Data Connections.

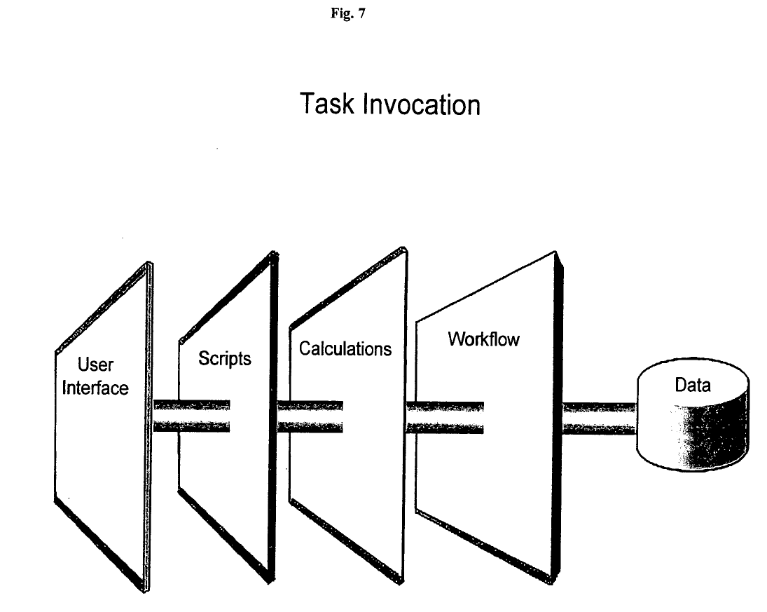

See FIG. 7

System Immunity

The goal is to have all aspects of the system configurable via our web interface; all design articulation being done though a menu, all coding performed within EISA. For example where a custom piece of logic needs expression with our EISA Connector Logic Language, there will be only one relevant place to do that, i.e. via a window peering into that part of the system where such expression is required.

System Omniscience

Everything relevant to the architecture from a systems integrity perspective will be known to the architecture. Everything will be contextual: Designers only see the options determined to be relevant to the system. These options are available for configuration based on its system context. The configuration choices—the fields of data in that part of the system being conFig.d—will be the only valid choices for the system designer to select.

The architecture supports an IMMUNE System by design. This is the IMMUNITY daemon that always checks system integrity is always aware of every aspect of itself. This is based on inter-relationships expressed with architecture's Connector Logic Language and Entity Relationship Builder [discussed below].

For the EISA, Connector Logic Language to connect deterministically, all GUI instruments (radio button groups, checklist groups, lookup widgets, data driven multi-select pick lists, query and substitute instruments, etc) will be componentized. This is accomplished via robust definition of each component's interface that anticipates all possible relevant uses of the component. These components, fully defined and the functions to associate them with one another will form the basis of the EISA BizLogic API.

The EISA Connector Logic Language calls on these components and dictates the syntax of expressions that deal with them. This includes the operators, the order of operations, the “sentence structure” and punctuation. The EISA BizLogic API's objects and methods are the nouns and verbs. Silicon Beach Systems uses this as an interpreted macro language at compile time, informing EISA how to compile and/or deploy itself, i.e. its various components based on the SBS Designers intent as expressed via the EISA Design Interface. This is codeless Intentional Programming, with an autonomous nervous system and immune system operating in the background at all times. This keeps the virtual representation of the enterprise self-referentially intact.

The source code for all programming consists of diagrams. From these business analyst created diagrams the designer's intent is articulated into an instance of EISA, across all aspects of the enterprise virtual desktop. Changes in the diagrams are used to reflect the designer's intentions and result in a new instance of EISA. Graphical Semantic Models produce all the source code in EISA. A picture truly is worth a thousand words, or in EISA's case at least a thousand lines of code.

Interface Design

Task Builder allows you to specify the data fields and their types that are in the table, as well the non-data element components such as views etc. associated with the task. Task Builder is the tool for screen layer design. Designers select instruments from the Tool Bar and they appear on the canvas. Every instrument's attributes can be specified and altered via the properties panel which appears to the right of the canvas.

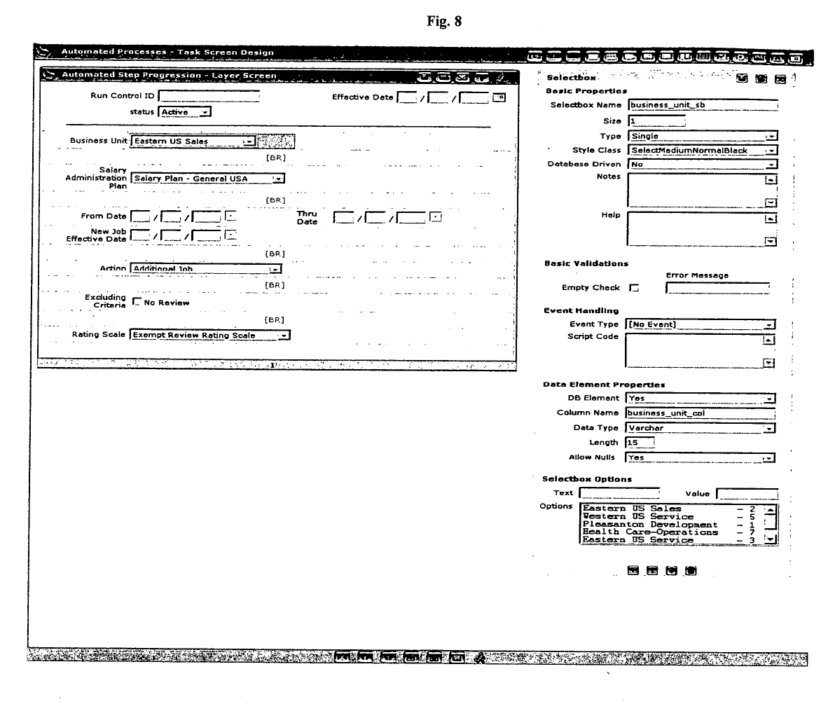

See FIG. 8.

When placing more complex instruments such as Lookups, which populate Views whose records come from a different table, which may not have been defined, the instrument may still be placed. Specifics may be later defined during another session with Task Builder once the dependent table has been defined. In other words, Task Builder is flexible enough to allow design even if all dependent aspects have yet to be defined.

As a part of this screen building process three control tables are populated.

Master Screen Descriptor Control Table

Each record in the Master Screen Descriptor Control Table pertains to a screen as well as a screen component/instrument specifying it uniquely as well as describing its spatial orientation/position, & instrument type. Instrument Types include (but are not limited to):
Label & Text Box with or without link to data element
Label & Text Box w/Look-up Pop-up View w/replace [Password & suppress label options on each]
Label
Hidden Field
Multi-line Text Box
Select List
Radio Group
Check Box Group
Email Link
Hyper Link
Lookup w/on Screen View
Submit
Clear Form
Image
File Upload
Select Box
Composite Instruments

Composite Instruments are made up of other instruments, e.g. Date Selector Instrument is composed of several pick lists, but together comprises one instrument.

An Instrument Table, defining each type of instrument available in the Task Builder Instrument Panel, can grow as new instruments are defined.

Due to the numerous types of components/instruments necessary to fully express a Task's GUI, helper tables are necessary to support the Master Screen Descriptor Table in areas such as:
Instrument connectivity—to tables and the criteria for determining result sets in views etc.
Instrument validation—for example, a text box can only have certain acceptable values which might correspond to a field in a table. Another text box may not correspond with a table field, but still may need to be validated to control its range of influence on the form. Therefore, validation needs to be separated from the lower data element level and attached to the more generic screen descriptor level. Instrument validation is another Instrument Parameter deserving its own sub-table linked to the Master Screen Descriptor Control Table.

Helper tables will be linked back to the Master Screen Descriptor Control Table instrument/data element record via the positional notation of the element.

Parameters regarding instruments such as, in the case of a lookup instrument the table or tables referenced in the lookup plus the search criteria variables/formula used when selecting the result set, need to be stored in another Screen Descriptor Helper table called the Instrument Parameters Table [WPT]. Each record in the WPT refers to a specific Instrument on a specific Task's Screen which is a specific record in the Screen Descriptor Control table. The Screen Rendering Engine reads Screen Descriptor Control table & its helper tables to paint screens.

I/O Design

For a given task, the records in the Master Screen Descriptor Control Table will often be a superset of the records for the same task in the Data Dictionary Control table. This is because items appearing on a task's screen will include more than just data elements.

Therefore, the notation to refer to fields in a table is simply an extension of the architecture's signature for that task, whereas the notation to uniquely identify a screen element generically cannot be the same notation as its members are a superset to the set of data elements alone.

Data Dictionary Control Table

Each record in the Data Dictionary Control Table corresponds with one data element in a task's primary table. This may or may not be visible on the screen used to perform this task. For example, some data elements in the table primarily associated with the task may not actually appear on the screen. This data element would appear in the data dictionary, but would not be represented in the Screen Descriptor Control Table.

Each record in the Data Dictionary Control Table would fully describe a data element's type and size etc. Validation data for the data element could be stored here as well or may be better stored in the Screen Descriptor Control table since a text box on the screen may not always correspond to a data element, yet still require validation because of the way designer wishes it to influence the submission of the form for example.

Help Control Table

The Help Control Table will store the tool text help for all items appearing on the screen in a given task. The Help Control Table will also contain longer narrative descriptions of each item on the screen.

Additionally, each task will have associated with it the Help text that describes the Task itself from a big picture perspective. All of this help is completely configurable via Task Builder with multilingual support built into the infrastructure.

Web Services Ready

Every task has at its disposal the infrastructure to describe using the Web services Description Language [WSDL] a task Descriptor which can be used within EISA itself or with the appropriate security parameters, to a published UDDI or Business Directory. Once published internally or externally for either B2B or other arrangements, a task built in EISA is reusable via the latest in Web Services technology.

Workflow Interface

A visual interface provides the business designer with the items required to articulate business logic.

A visual programming language, ABL allows the designer to visually link any part of the system to any other part of the system via an intuitive flow-based tool.

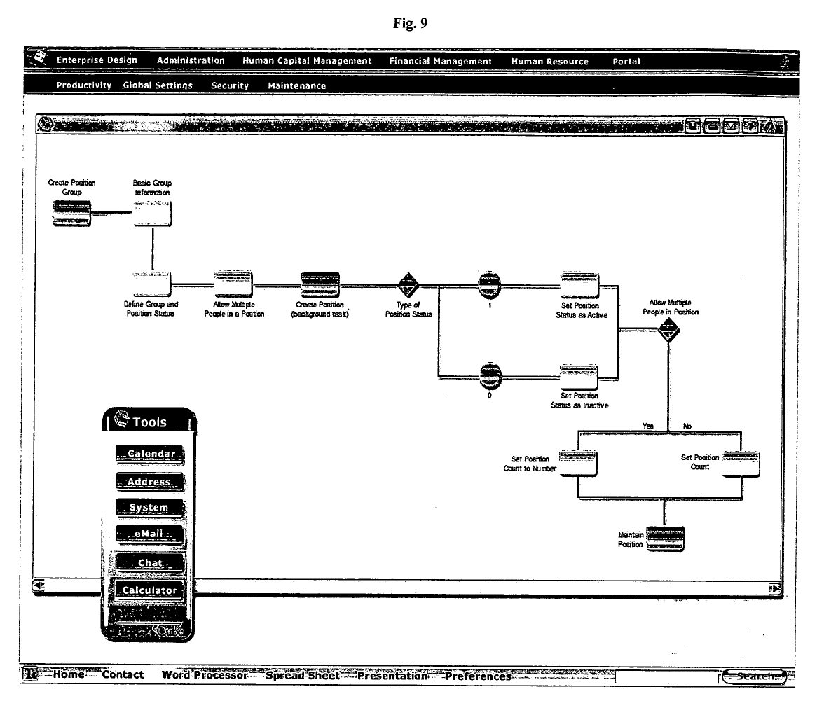

The connecting lines between items in the system, always at the task level, will denote the relationship between entities. This provides the ability to denote the type of relationship, direction of flow via different types of lines, line terminals, and the ability to apply code blocks and looping structures as nodes to handle complex business logic. See FIG. 9

Designers connect different tasks and their fields with visual code components such as loop symbols, incremental symbols or branching logic symbols with branching based on values or other fields in other tables. Every symbol on the visual design canvas—tables, their fields, all programmatic symbols—are drag and droppable, and all of their properties configurable via context aware pick lists. In turn all symbols can be wired together via drag and drop connector logic lines, producing a completely visual codeless environment supporting the latest in Aspect-Oriented Technology.

I/O Module—Web Services:

Central to EISA is its ability to facilitate communication between any data source combination. Using advanced Web services with secured XML and adapter technologies, Communicator has the unique ability to implement advanced data communication without the need to have extensive in-house expertise.

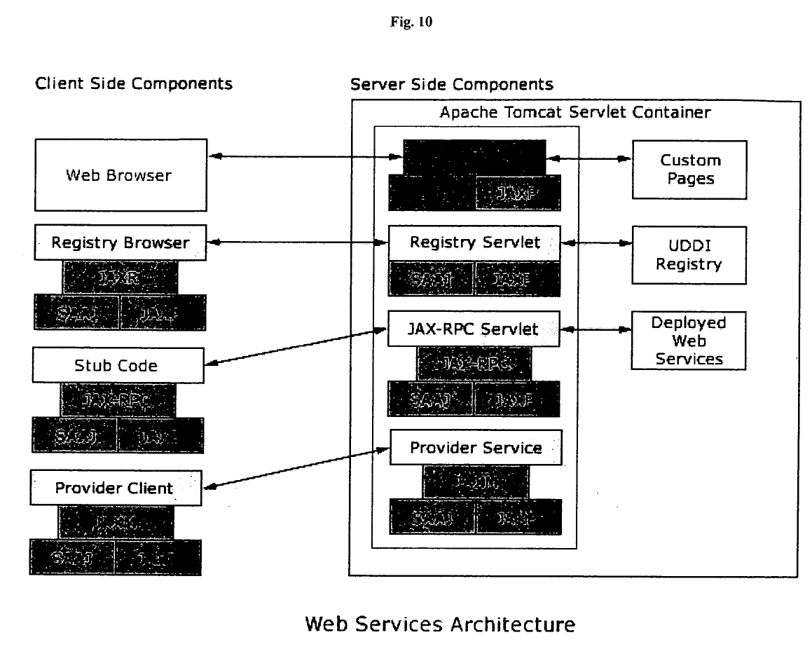

See FIG. 10

I/O module supports database-to-database, file-to-file, XML-to-XML plus any combination and order of the above. Where proprietary data sources are found, adapter technology is employed to produce a conduit from the proprietary source to XML and from there any other output or input type.

Communicator can convert any XML format into any other format via fill support of XSL and XSLT technologies.

Conversions, transfers, and transformation profiles can be designed via Communicator's graphical web based pick list driven technology. Once designed, these profiles may be invoked on an ad hoc basis or any combination of calendar or event driven schedules, all configurable via a scheduling control panel.

Of course, all Communicator profiles have associated security parameters which tie into Security Access and Security Monitor Subsystems. This assures that all aspects of the session are authenticated and authorized. Authentication ensures that the entity is the actual entity. Authorization ensures that the entity has permission to perform the operation. Often, a chain of custody is involved in an I/O process. The transfer may begin in part of the system and continue to other parts of the system, each section having its own security requirements and differing levels of authentication and authorization.

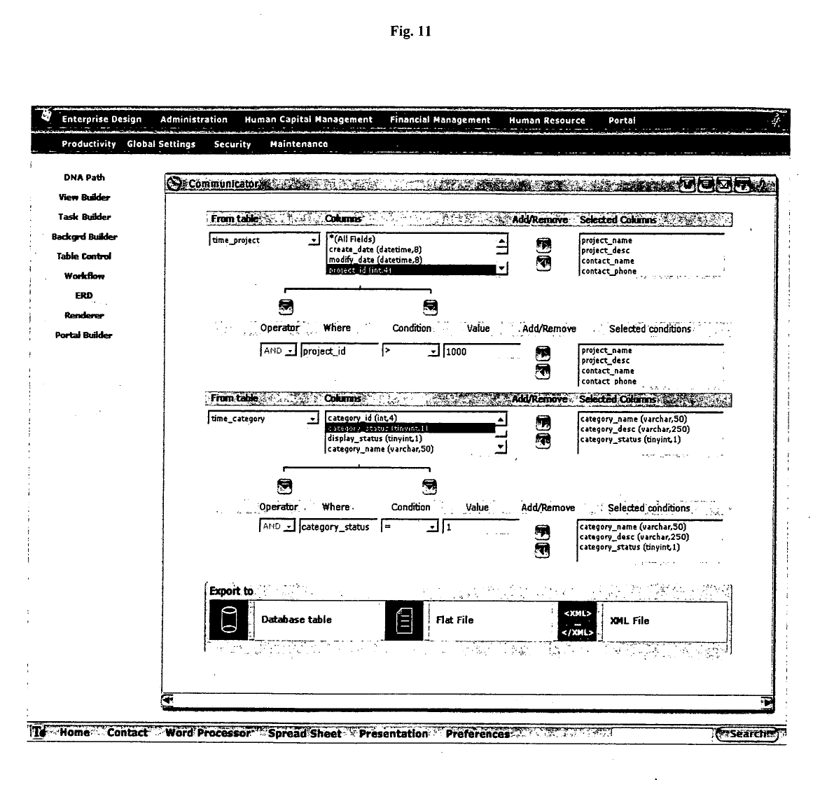

I/O Communication Definitions—see FIG. 11

Time-Based Tasks

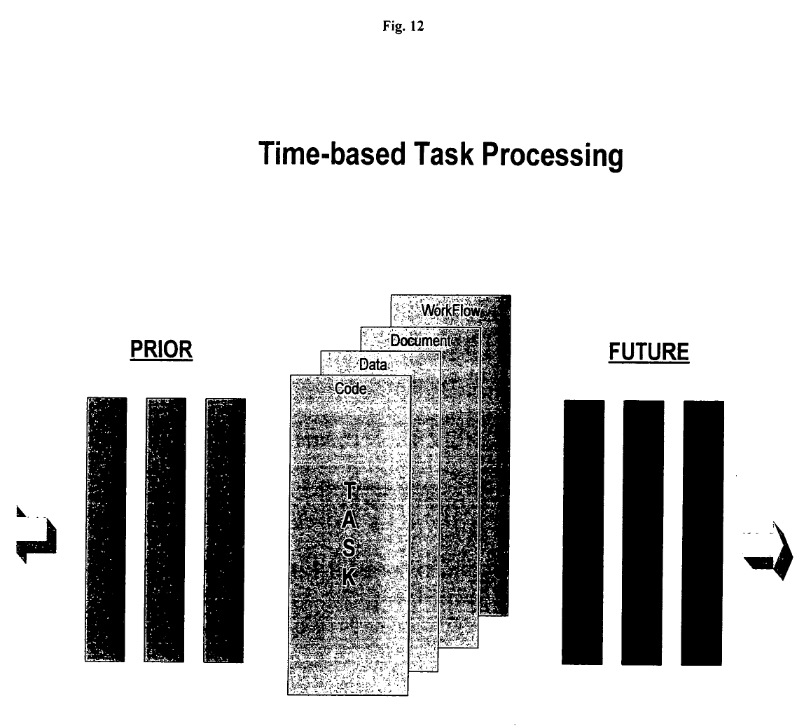

EISA incorporates unrivaled operational data modeling and temporal data management capabilities. EISA's operational data modeling & temporal data management infrastructure is built into every node in the system. EISA separates these concerns from the system articulation process enabling the enterprise to focus on core business processes instead of the mundane yet seldom achieved task of building a system with complete control over data archival and modeling functionality. See FIG. 12

EISA's operational data modeling and temporal data-management infrastructure facilities include:
future-dated records that will come into effect later
creating multiple models of records for what-if-analysis without affecting actual system
archival of multiple versions of records as their effective dates expire
archival of every transaction so a complete record of all activities is retrievable.
use of an indicator field that allows any number of permutations within any number of future date versions

The three main fields that every table/task in EISA relies upon to implement this infrastructure are:
Primary Key
Effective Date
Indicator [options configurable per task/table at design time in TASK BUILDER]

To understand how it works, it is useful to go over some rules and scenarios to demonstrate the rules.

The current version of a particular record is the earliest future record when future versions exist.

So consider the following . . .

SCENARIO I—Edit and Delete Modes

In a New Hires table there exists a record with primary key 15 and effective date of Dec. 20, 2002.

There also exists another record with primary key 15 and effective date of Dec. 22, 2002 and yet another with an effective date of Dec. 25, 2002.

While it may not make sense to have so many of the same record with different effective dates, many systems would like to have such a capability.

In any case, EISA would determine that the current record is the one with an effective data of Dec. 20, 2002 if today is Dec. 10, 2002.

If today were Dec. 21, 2002, then EISA would return the version of record with Primary Key 15 with effective date of Dec. 22, 2002, and would also have archived the version with effective date of Dec. 20, 2002 at 12:01 am the night before via a behind the scenes infrastructure daemon process to the history version of the New Hires Table. A system notation would also be made in the current version of the record denoting presence of historical version to obviate need to search history when updating PCF time scope.

Now there would be a version of record 15 in the history table, as well as two versions of the record in the current New Hires table.

If today were Dec. 21, 2002, and a user entered 15 in the Position No: [Primary key] field and hit enter, not specifying an effective date, or Status Indicator, EISA would return the record 15 with an effective date of Dec. 22, 2002. The PCF Time Scope P and F bulbs would be lit and clickable, and C would be off and not clickable. If the user were to click on the F bulb, a list of the Future records would appear and permit selection of a different future record, replacing the current screen contents with its field values. The same is true if the user were to click on the P bulb, i.e. a list of past versions of record 15 would be selectable from a pick list widget. In this case, only one past version would exist, the recently archived 15 with effective date of Dec. 20, 2002.

If a user edits or deletes the version they are working on, the old version is archived to history, and the altered version remains in the current table and in case of deletion, the record is removed from the current table.

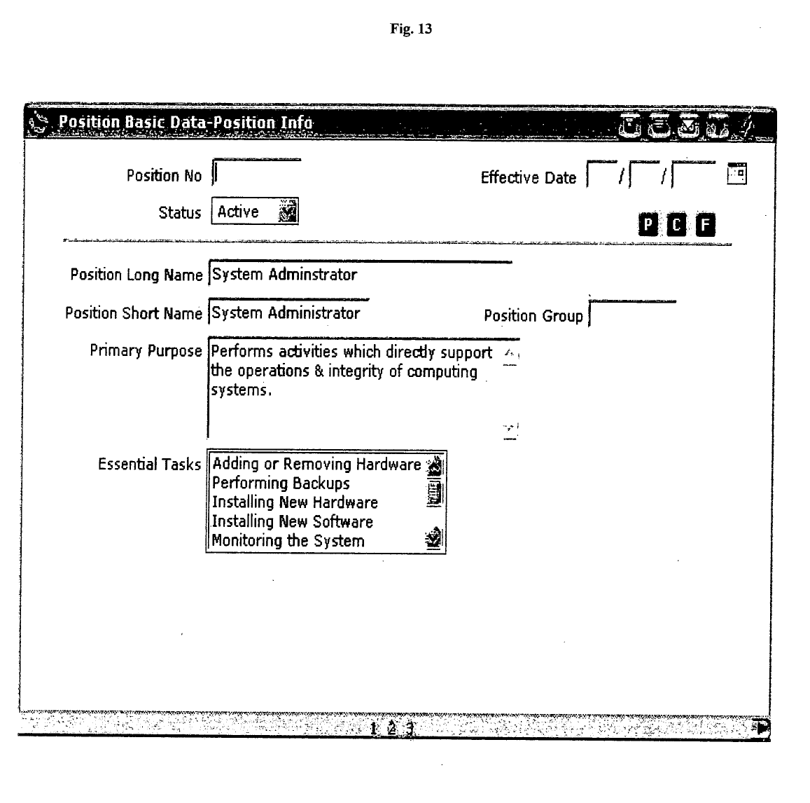

See FIG. 13

SCENARIO II—Insert Mode

Another scenario might be if the user were to use the same screen after typing a 15 in the primary key field and before pressing enter they were specify a date in the Effective date field. If the date they entered did not exist for record 15, e.g. Dec. 30, 2002, EISA would enter Insert Mode and would create a future version of record 15.

As in the previous scenario, the PCF time scope indicators would light up according to the versions of record 15 with Status Active that exist after the user presses enter. This notifies the user of what already exists for the record 15 so the user can decide if they really want to add another version, or see what past versions have already been archived etc. This type of power is unheard of in systems, yet highly sought after. EISA provides this power to every table/task in the system via its powerful infrastructure.

Security Schema

The security schema is cascading in the sense that there is a hierarchical scoping of security domains, wherein lower domains can only further restrict the baseline levels of access granted at successively higher levels.

See FIG. 14.

Every Security Infrastructure Must Address Who, What, When and Where.

1. Who—User
2. What—Resources
3. When—Time of day, day of week, etc
4. Where—Physical location of user, IP address or comparable

The security schema provides maximum flexibility via a unique, model based, highly granular level of permission articulation across your entire enterprise.

Security is comprised of three major domains:
1. Global Level
2. Resource Level
3. When and Where Level
   Global Level

At the global level, there is no differentiation between resources, i.e. all resources are treated equally. For example, a security setting at the global level would, for a particular user, apply across every resource and would not differ between two resources.

Resource Level Security

Broadly speaking, resources all nodes within the architecture.

Via resource level security, any node may be turned on or off via access control.

Resource nodes exist in the following states:
1. Menu Item Visible, Writable, and Accessible
2. Menu Item Visible, Not Writable, and Accessible
2. Menu Item Invisible and Inaccessible
   Field/Screen Element Level Security

To achieve fine-grain access control over individual data columns, the EISA security architecture permits permission down to the field/screen element level. [FSE]

FSE Level security is set per field/screen element for a given task with one of the following settings:
1. Visible Read/Only [VRO]
2. Visible Read/Write [VRW]
3. Invisible

Visible Read/Only means that while a data field on a screen for given task may be visible; its contents cannot be modified. Visible Read/Write would permit modification of the field's contents. An Invisible security setting on a field would as the name suggests render that field invisible for that user on that task's screen.

Just as the Global Security Settings determine the baseline for the Resource Level Security Settings, the Task Level Security Settings determine the baseline for the Field Level settings. In other words, a Field Level Security Setting for a particular user can never grant more access than is permitted for the task as a whole.

Relationship between Task and Field Security Levels

Task level security sets the baseline for field level security, i.e. a field level setting may never grant greater access than its home task's security baseline. Field level security can further restrict the task level baseline. Fields that appear in other tasks as foreign fields, can be set independently of the task level security of their home task, however, they must not exceed the limitations of the task level security of the host task they are associated with either. EISA provides the ability to lock Field Level Security across every task the field appears in, both as a native or foreign field.

Foreign & Home Fields & Paths

It is important here to point out that when a field appears in another path, i.e. not its home path, that it is regarded as a FOREIGN FIELD. As such, the FOREIGN Path's Cascading Hierarchy determines rules governing its access in the FOREIGN PATH.

An example of a home field is when a field belongs to a task's primary table. Sometimes it is necessary to use that same field in another task's screen. When this occurs, the field is treated as a FOREIGN FIELD by that task, and is subject to the Cascading Security Rules for that task and that task's path. A PATH in general is defined simply as the click sequence of menus traversed to get to the item in question, e.g. System, Application, Work Area, Task, and Field is a Fully Qualified Path to a particular field, each resource possessing its own path, each being subject to the Cascading Security Rules of the path to which it belongs.

Field level security is global in nature, and may be aggregated into functional groups assigned during screen/table building sessions. Field level security is Global in the sense that a column's security follows it no matter where it appears throughout the system. This assures security administrators that once the security is set for a particular column, say a salary column, that no matter where it is used in the system, that no one who should not see or change it etc will be able to.

[Field level security can be aggregated into functional groups so that security administrators will be able to perform bulk administration of security on those fields, which have common security requirements. Aggregation also facilitates reporting for security purposes on functional data groups so that it is easy to determine who has access to which data columns.

When and Where Level

Discriminators available in the articulation of security include, on a per user basis, the following:
1. Physical Location (e.g. IP address and or range)
2. Temporal Data (date range, days of the week, time of day etc.)

Each of these discriminators can be applied at both the Global and Resource Levels.

Resource Level security settings can never grant more access than Global Level provides, but can further restrict access on a resource-by-resource basis.

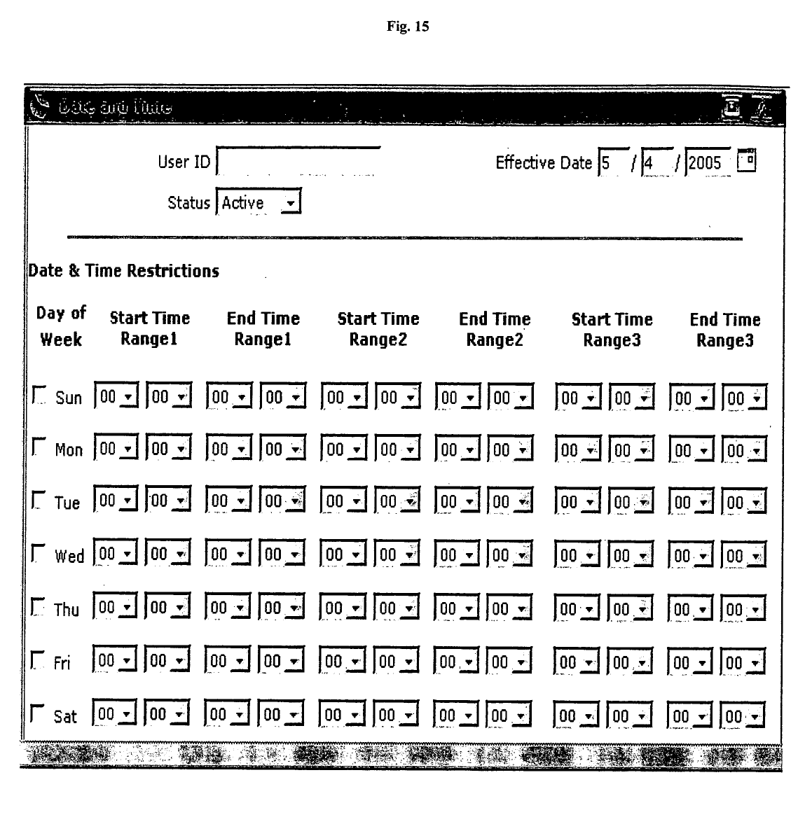

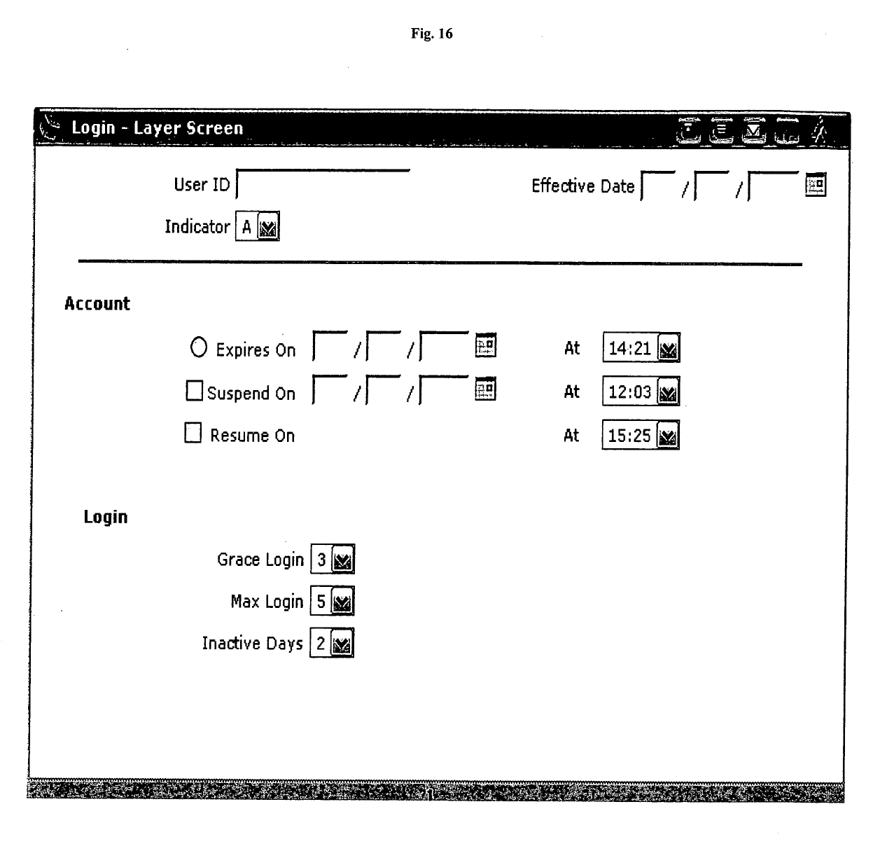

See FIGS. 15 and 16

### FIG. 16

Security Authorization

To determine whether an enterprise resource is available for access and the terms for such access, the architecture authorization engine needs to know several things:
Which User
What Resource
When
From Where

With these 4 key pieces of data, the authorization engine can make the determination and grant authorization for access, and govern the terms for such access. The authorization model divides security into global and resource levels, where at the Global Level if the time and location is correct, a certain user can either access or not access all of the enterprise resources. Within the Global Level of access, when access is authorized, architecture security further breaks out the method of access to be either read only or read write, again without differentiation at the resource level but across the board, i.e. globally for a particular user.

At the Resource Level, architecture security achieves a higher degree of granularity, breaking out security into Node and Field levels respectively. For a given user, the authorization engine will grant access to certain resources, with either read only or read/write privileges during certain times and from certain locations. Like the menus that lead finally to tasks, access to both is governed at the resource level.

Resource Level Security settings can only further restrict access provided at the Global Level, and never grants greater access than Global provides.

Security Modeling

Architectural security takes the unique approach to security articulation by offering the best of both worlds in the traditional sense. Traditional approaches to access control include:
Role Based Access Control
User Based Access Control

Each approach possesses relative strengths and weaknesses. The User Based approach has the strength of ultimate fine grain control, but the weakness of no ability to generalize. Whereas the Role based approach offers the ability to generalize security to roles, but not every user perfectly fits a role or even a combination of roles, leaving a security articulation that is full of holes and gaps.

This dilemma is solved via EISA's Cascading Model Security Architecture [CMSA] whereby ultimate infinitely customizable fine grain mapping of users to resources is possible while still possessing the ability to generalize.

Security models can be articulated via EISA Security Modeler and applied to individual users. Then users' profiles can be further customized from the baseline they were modeled from. Even models can be applied to create other models, which then can be changed slightly to achieve any particular security profile sought.

Primitive Default Models

EISA comes with three primitive unchangeable default models from which all models are derived.
1. All Resources—Read Write
2. All Resources—Read Only
3. All Resources—No Access

Each of these primitive default models can be used in a locked mode to quickly implement security administration tasks such as open the enterprise up completely to a particular user, or shut it down for a particular user in one fell swoop.

All models created in EISA must have as their origin one of the three default primitive models, or any existing model [which in turn started from a default model]. EISA also comes with common models encountered in various application specific scenarios such as Human Capital Management for example.

Locked Model Concept

EISA even has the ability to function as if it were a traditional Role Based Access Control [RBAC] system, making it a hybrid where the sum of the parts really is greater than the whole. Via EISA's unique Locked Model Concept, models may be locked. Users' profiles that were modeled from a locked model cannot be changed. This guarantees that all users modeled from the same locked model have identical access rights to the same resources, thereby effectively providing traditional RBAC functionality.

User profiles modeled on a locked [or unlocked for that matter] model are automatically updated to reflect changes to that model if desired. If it is not desired that all users associated with a locked model be updated to reflect changes to that model, then it is best to first model those users on themselves¹, thereby breaking the locked model association for those users, yet retaining their current profiles.

When modifications are made to a locked model, all user profiles derived from that locked model are automatically updated accordingly. This is accomplished via workflow, with resultant profiles in line with the new model as if a role's rights had been changed in a traditional RBAC sense.

A locked model is akin to a “sticky” mode where users become strongly associated with the locked model their profiles were modeled on.

When a change is made to either a locked or unlocked model, an option is provided to propagate these changes to every user profile with that active model. The point should be made here that when not using locked models, a user's profile is not strongly associated with the unlocked model it was modeled on. In fact this user's profile can deviate from the unlocked model it was modeled on over time via ad hoc edits to that user's profile. In this case, the active model can be considered the most recent model.

Like any other table in EISA, bulk updates of profiles can be performed at the System level as well, via standardized GUI facilitated SQL queries.

It can thus be seen that a new useful method and system for creating an Enterprise Information System Architecture have been provided. In view of the many possible embodiments to which the principles of this invention may be applied, it should be recognized that the embodiments described herein with respect to the drawing figures are meant to be illustrative only and should not be taken as limiting the scope of invention. For example, those of skill in the art will recognize that the elements of the illustrative embodiment shown in software may be implemented in hardware and vice versa or that the illustrative embodiment can be modified in arrangement and detail without departing from the spirit of the invention. Therefore, the invention as described herein contemplates all such embodiments as may come within the scope of the following claims and equivalents thereof.

1. A method for creating comprehensive Enterprise Information Systems based on the Enterprise Information System Architecture described in this document comprising the steps of:
Building an n*n*n component-based architecture
Providing an open enterprise integration infrastructure which includes open collaboration with all external system components
Building process integration with a comprehensive exchange infrastructure
Providing infrastructure management
Processing program-related time-based
Creating a model-based cascading security system based on the n*n*n component-based architecture

2. An Enterprise Information System based on the Enterprise Information System Architecture comprising the components of:
An n*n*n component-based architecture
An open enterprise integration infrastructure which includes open collaboration with all external system components
Process integration with a comprehensive exchange infrastructure
Infrastructure management
Program-related time-based activities
A model-based cascading security system based on the n*n*n component-based architecture
